(19) United States
(12) Patent Application Publication
(10) Pub. No.: US 2011/0177404 A1
(43) Pub. Date: Jul. 21, 2011

(54) FUEL CARTRIDGE OF FUEL CELL AND METHOD FOR OPERATING FUEL CARTRIDGE

(75) Inventors: Kuo-Tai Hung, Hsinchu County (TW); Cheng Wang, Hsinchu County (TW)

(73) Assignee: YOUNG GREEN ENERGY CO., Hsinchu County (TW)

(21) Appl. No.: 12/944,731

(22) Filed: Nov. 12, 2010

(30) Foreign Application Priority Data
Jan. 15, 2010 (CN) 201010002984.9

(51) Int. Cl. H01M 8/04; H01M 8/06

(52) U.S. Cl. 429/416; 429/444; 429/515

(57) ABSTRACT

A fuel cartridge of a fuel cell and a method for operating the fuel cartridge are provided. The fuel cartridge has a plurality of fuel units. At least one first fuel unit is selected form the fuel units and the first fuel unit is triggered to provide a fuel to the fuel cell. If the fuel produced by the first fuel unit is insufficient to provide for the fuel cell, at least a second fuel unit is selected from the fuel units. A temperature of the second fuel unit is detected, and if the temperature of the second fuel unit is lower than an upper-limit operating temperature, the second fuel unit is triggered to provide the fuel to the fuel cell.

### CROSS-REFERENCE TO RELATED APPLICATION

This application claims the priority benefit of China application serial no. 201010002984.9, filed on Jan. 15, 2010. The entirety of the above-mentioned patent application is hereby incorporated by reference herein and made a part of this specification.

### BACKGROUND OF THE INVENTION

1. Field of the Invention

The invention relates to a fuel cell. More particularly, the invention relates to a fuel cartridge of a fuel cell and a method for operating the fuel cartridge.

2. Description of Related Art

Development and application of energy have always been indispensable conditions of human life, however, the development and application of energy may damage the environment. It has advantages of high efficiency, low noise and pollution-free, etc. to use a fuel cell technique to generate electric energy, which is an energy technology in line with a trend of the times.

A commonly used fuel cell system approximately includes a fuel cartridge and a fuel cell, etc. Therein, the fuel cartridge is used for providing hydrogen (H₂) to the fuel cell to generate electric power, and the fuel cell is used to cause a chemical reaction to the hydrogen to produce the electric power, and provide the electric power to an electronic system for utilization.

Generally, most of the conventional fuel cartridges use a one-time reaction of boron-based compounds hydrogen-storage technology, and water (H₂O) is added to enable the chemical reaction to continuously generate hydrogen for the fuel cell. However, since the conventional fuel cartridge is designed as a large chamber, and the chemical reaction produced when the boron-based compounds hydrogen-storage technology is applied to such fuel cartridge is a one-time reaction, the hydrogen may be continuously generated until the chemical reaction between sodium borohydride (NaBH₄) and water is totally completed. Therefore, even if the electronic system does not consume the electric power provided by the fuel cell, the fuel cartridge still continuously provides hydrogen to the fuel cell, which may cause a waste of the hydrogen and electric power, and the hydrogen provided by the fuel cartridge may be sufficiently utilized.

### SUMMARY OF THE INVENTION

The invention is directed to a fuel cartridge of a fuel cell and a method for operating the fuel cartridge, which reduces a waste of hydrogen and electric power, so as to avoid producing a high temperature to damage the fuel cartridge.

An embodiment of the invention provides a method for operating a fuel cartridge of a fuel cell. The fuel cartridge includes a plurality of fuel units. At least one fuel unit (which is referred to as a first fuel unit hereinafter) is selected from the fuel units, and the first fuel unit is triggered to provide a fuel for the fuel cell. If the fuel produced by the first fuel unit is insufficient to provide for the fuel cell, at least another fuel unit (which is referred to as a second fuel unit hereinafter) is selected from the fuel units. A temperature of the second fuel unit is detected. If the temperature of the second fuel unit is lower than an upper-limit operating temperature, the second fuel unit is triggered to provide the fuel for the fuel cell.

An embodiment of the invention provides a fuel cartridge of a fuel cell. The fuel cartridge includes a plurality of fuel units, a temperature sensing device and a control unit. The temperature sensing device detects temperatures of the fuel units. The control unit is electrically connected to the fuel units and the temperature sensing device. The control unit selects and triggers at least one of the fuel units (which is referred to as a first fuel unit hereinafter) to provide a fuel for the fuel cell. If the fuel produced by the first fuel unit is insufficient to provide for the fuel cell, at least another fuel unit (which is referred to as a second fuel unit hereinafter) is selected from the fuel units. If a temperature of the second fuel unit is lower than an upper-limit operating temperature, the second fuel unit is triggered to provide the fuel for the fuel cell.

In an embodiment of the invention, the method for operating the fuel cartridge further includes selecting at least another fuel unit (which is referred to as a third fuel unit hereinafter) from the fuel units if the temperature of the second fuel unit is higher than the upper-limit operating temperature, and triggering the third fuel unit to provide the fuel, wherein the third fuel unit is not adjacent to the first fuel unit.

In an embodiment of the invention, the method for operating the fuel cartridge further includes detecting temperatures of the fuel units, and triggering a heating device to heat the fuel units if the temperatures of the fuel units are lower than a lower-limit operating temperature.

In an embodiment of the invention, the step of triggering the first fuel unit includes triggering a heating device to burn a diaphragm of the first fuel unit, so that a chemical reaction is occurred between a first reactant and a second reactant in the first fuel unit to provide the fuel.

In an embodiment of the invention, the step of triggering the first fuel unit includes piercing a diaphragm of the first fuel unit, so that a chemical reaction is occurred between a first reactant and a second reactant in the first fuel unit to provide the fuel.

In an embodiment of the invention, the first reactant and the second reactant are chemical hydrogen-storage materials, and the fuel comprises hydrogen.

The embodiments of the invention have at least one of the following advantages. Since the fuel cartridge is divided into a plurality of fuel units, and a chemical reaction may be occurred in each of the fuel units alone without being influenced by the other fuel units, one or more fuel units may be selectively triggered according to a power requirement of a load, so as to reduce a waste of the hydrogen and electric power. Moreover, an amount of the reactant used for each chemical reaction in the fuel cartridge of the invention is far less than that of a conventional technique, so that a problem of fuel cartridge damage due to high temperature generated by the chemical reaction may be mitigated. Even more, the fuel cartridge of the invention may detect the temperatures of the fuel units to select a next fuel unit to be triggered, so as to avoid a mutual heat accumulation of the tandem triggered fuel units, and therefore the problem of fuel cartridge damage due to high temperature generated by the chemical reaction may be further mitigated.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a fuel cell system according to an embodiment of the invention.

FIG. 2 is a schematic diagram illustrating a fuel cartridge of a fuel cell according to an embodiment of the invention.

FIG. 3 is a diagram illustrating a sequence that a control unit triggers all of fuel units of FIG. 2.

FIG. 4 is a schematic diagram illustrating a fuel cartridge of a fuel cell according to another embodiment of the invention.

FIG. 5 is a flowchart of a method for operating a fuel cartridge of a fuel cell according to an embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

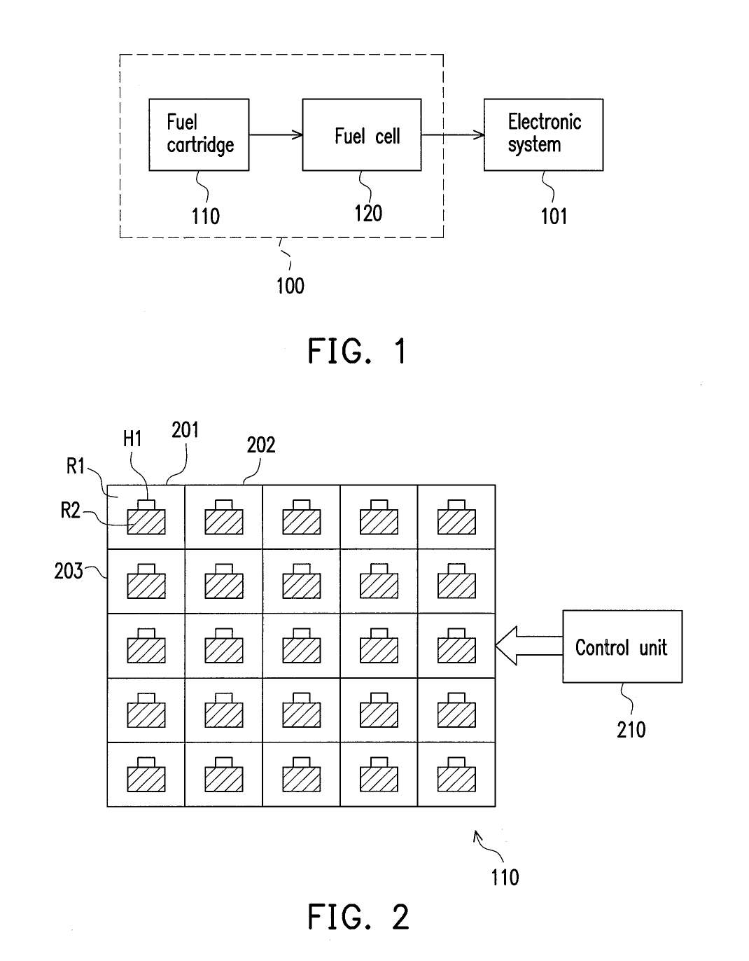

FIG. 1 is a schematic diagram illustrating a fuel cell system 100 according to an embodiment of the invention. Referring to FIG. 1, the fuel cell system 100 is used for providing electric power to an electronic system (i.e., a load) 101. The fuel cell system 100 includes a fuel cartridge 110 and a fuel cell 120. The fuel cartridge 110 generates a fuel (for example, hydrogen) to the fuel cell 120. The fuel cell 120 is coupled to the fuel cartridge 110, and is electrically connected to the electronic system 101. The fuel cell 120 absorbs the fuel generated by the fuel cartridge 110 and performs a chemical reaction to produce the electric power, and then supplies the electric power to the electronic system 101.

In the embodiment, the fuel cell 120 may be a proton exchange membrane fuel cell (PEMFC) or a direct methanol fuel cell (DMFC), though the invention is not limited thereto. Taking the PEMFC as an example, the PEMFC is mainly consisted of a proton exchange membrane, an anode, and a cathode. Therein, the fuel at the anode of the fuel cell 120 reacts with a catalyst to generate hydrogen ions and electrons, and a chemical reaction formula thereof may be represented as:

2H₂→4H⁺+4e⁻

Moreover, the electrons generated by the chemical reaction at the anode of the fuel cell 120 may flow back to the cathode of the fuel cell 120 through various circuits (e.g. the electronic system 101). The hydrogen ions generated by the chemical reaction at the anode penetrate through the proton exchange membrane of the fuel cell 120 and move towards the cathode, and are further reacted with the electrons and oxygen at the cathode of the fuel cell 120 to generate water, and a chemical reaction formula thereof is represented as:

4H⁺+4e⁻+O₂→2H₂O

Therefore, a total chemical reaction formula of the PEMFC may be represented as:

2H₂+O₂→2H₂O

The method of generating the electric power by the fuel cell 120 has been known by those skilled in the art, and therefore detailed description thereof is not repeated. The current commonly-used fuel cell or any other type of the fuel cell in the future may be used to implement the fuel cell system 100. Embodiments of the fuel cartridge 110 are described below.

FIG. 2 is a schematic diagram illustrating the fuel cartridge 110 of a fuel cell according to an embodiment of the invention. The fuel cartridge 110 includes a plurality of fuel units, for example, fuel units 201, 202 and 203 (for simplicity, only three of the fuel units are symbolized). The fuel units illustrated in FIG. 2 are arranged in an array of 5×5, though it is an example of the fuel cartridge 110. In other embodiments, a number and an arrangement method of the fuel units 201, 202, 203, . . . in the fuel cartridge 110 may be different to that of FIG. 2, and the arrangement method of the fuel units 201, 202, 203 . . . may be a honeycomb-shape, linear and a three-dimensional stack, etc. Each of the fuel cells 201, 202, 203 . . . has a chamber, and each chamber contains a first reactant and a second reactant. Taking the fuel unit 201 as an example, it has a first reactant R1 and a second reactant R2. The other fuel units (e.g., the fuel units 202 and 203) are similar to the fuel unit 201.

The first reactant R1 may be a hydrogen-containing reactant or a chemical hydrogen-storage material, for example, water (H₂O), though the invention is not limited thereto. The second reactant R2 may be a chemical hydrogen-storage material or a hydrogen-containing reactant, and the second reactant R2 may have a solid state or a liquid state, which can be sodium borohydride (NaBH₄) and lithium hydride, etc., though the invention is not limited thereto. In some embodiments, the first reactant R1 may be NaBH₄, and the second reactant R2 may be water. A diaphragm is disposed between the first reactant R1 and the second reactant R2 for isolation. The diaphragm may be a phase change material, for example, cere or other materials such as plastic, and there is no chemical or physical reaction occurred between the diaphragm and the reactants R1 and R2. The diaphragm may isolate the first reactant R1 from the second reactant R2 by different means. For example, the diaphragm may be used to divide the chamber of the fuel unit 201 into two sub chambers for respectively containing the reactants R1 and R2. Alternatively, the diaphragm may totally wrap the second reactant R2 to isolate the second reactant R2 from the first reactant R1.

In the embodiment, when the first reactant R1 contacts the second reactant R2, the chemical reaction formulas of the chemical reactions generated there between are as follows, though the invention is not limited thereto:
1. [CH₃N(H)BH₂]₃→>[CH₃NBH]₃+3H₂;
2. nNH₄X+4MHₙ→Mxₙ+M₃Nₙ+4nH₂;
3. N₂H₆X₂+8/nMHₙ→2/nMxₙ+2/nM₃Nₙ+7H₂;
4. (NH₄)₂SO₄+16/nMHₙ→4M_{2/n}O+M_{2/n}S+2/nM₃Nₙ+12H₂;
5. N₂H₆SO₄+16/nMHₙ→4M_{2/n}O+M_{2/n}S+2/nM₃Nₙ+11H₂
6. LiBH₄→LiH+B+(3/2)H₂;
7. Ni+2H₂O→Ni(OH)₂+H₂; and
8. NaBH₄+2H₂O→NaBO₂+4H₂.

The control unit 210 is electrically connected to all of the fuel units. The control unit 210 selects at least one fuel unit (which is referred to as a first fuel unit, for example, the fuel unit 201) from the fuel units, and triggers the fuel unit 201 to provide the fuel (for example, hydrogen) for the fuel cell 120. The so-called “trigger the fuel unit 201” refers to that the control unit 210 triggers a server device H1 to break the diaphragm between the reactants R1 and R2. The server device H1 may include a physical breaking mechanism such as a heating device (for example, a heating wire) or a piercing mechanism, etc. After the heating device burns or melts the diaphragm of the fuel unit 201 (or the piercing mechanism pierces the diaphragm of the fuel unit 201), the first reactant R1 and the second reactant R2 in the fuel unit 201 are mutually contacted, and cause a chemical reaction, so as to produce and provide the fuel (for example, hydrogen) to the fuel cell 120.

If the first reactant R1 or the second reactant R2 in the fuel unit 201 is to be exhausted, an amount of the fuel provided by the fuel unit 201 is gradually reduced. In the embodiment, when the fuel generated by the fuel unit 201 is insufficient for providing to the fuel cell 120, the control unit 210 sequentially selects at least another un-triggered fuel unit (which is referred to as a second fuel unit, for example, the fuel unit 202) from all of the fuel units, and triggers the second fuel unit 202. When the load is removed, for example, the electronic system 101 is turned off or a power line thereof is disconnected from the fuel cell 120, the control unit 210 correspondingly stops selecting and triggering other fuel units. Therefore, the fuel cartridge 110 may selectively trigger one or more the fuel units according to a power requirement of the load, so as to reduce a waste of the fuel (for example, hydrogen) and electric power. Moreover, an amount of the reactant used for each chemical reaction in the fuel cartridge 110 of the embodiment is far less than that of a conventional technique, so that a problem of fuel cartridge damage due to the high temperature generated by the chemical reaction may be mitigated.

In some applications, if an environmental temperature is too low, a reaction temperature of the fuel cartridge 110 may be insufficient, so that a performance of the fuel cell system 100 is decreased. In the embodiment, a sequential triggering operation method is used, so that the reaction heat generated by the prior triggered fuel unit 201 may be used to heat the adjacent fuel unit 202. Therefore, in case of the low temperature application environment, the triggered fuel unit 202 can be maintained at an optimal reaction temperature, so that a better performance of the fuel cell system 100 may be maintained.

In another low temperature application, the control unit 210 may drive the heating devices of the server devices H1 in a part of or all of the fuel units. By driving the heating devices, the triggered fuel units may be maintained at an optimal reaction temperature, so that a better performance of the fuel cell system 100 is achieved.

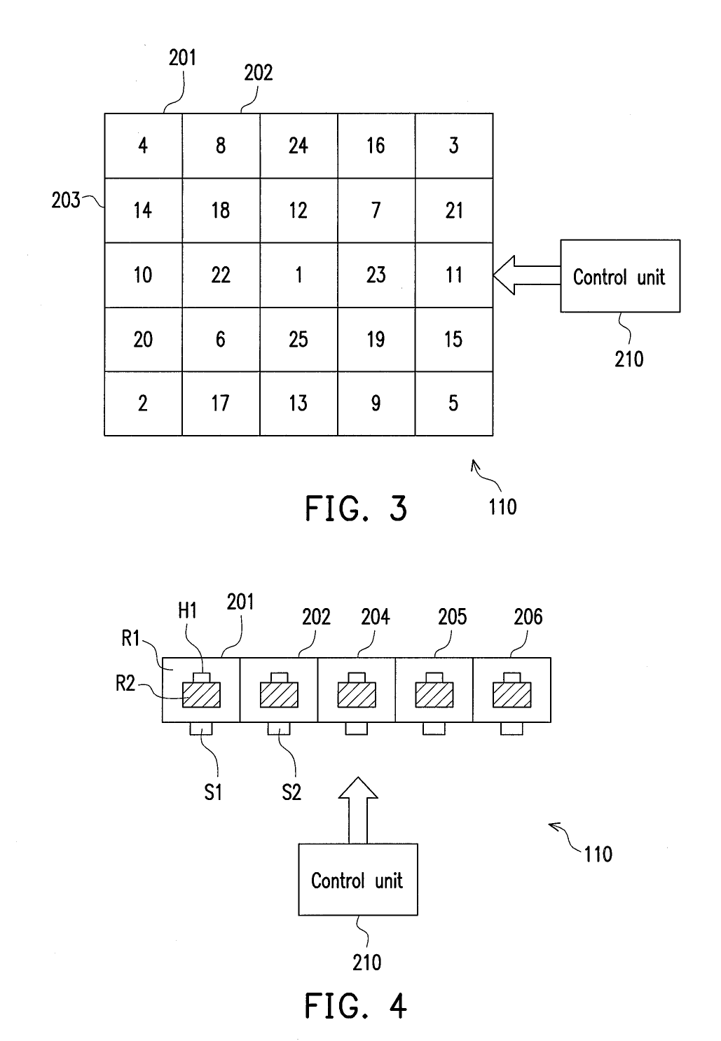

In the above embodiment, the prior triggered fuel unit 201 and the follow-up triggered fuel unit 202 are located adjacent to each other. In some applications, if the environmental temperature is too high, the above sequential triggering operation method may probably lead to an excessive high reaction temperature to cause a damage of the fuel cartridge 110 or a damage of the fuel cell 120. Therefore, in some embodiments, the control unit 210 may randomly trigger a next fuel unit or select to trigger a next fuel unit according to a specific rule, wherein the prior triggered fuel unit 201 (the first fuel unit) is not adjacent to the follow-up triggered fuel unit (the second fuel unit). For example, FIG. 3 is a diagram illustrating a sequence that the control unit triggers all of the fuel units of FIG. 2. Referring to FIG. 3, numbers in the blocks represent a triggering sequence of the fuel units. In this way, consecutive reactions of two adjacent fuel units may be avoided.

FIG. 4 is a schematic diagram illustrating the fuel cartridge 110 of a fuel cell according to another embodiment of the invention. The fuel cartridge 110 includes a plurality of fuel units (for example, the fuel units 201 and 202) and a plurality of temperature sensing devices. The fuel units 201, 202, 204, 205 and 206 illustrated in FIG. 4 are arranged in a linear approach, though it is an example of the fuel cartridge 110. In the other embodiments, a number and an arrangement method of the fuel units in the fuel cartridge 110 may be different to that of FIG. 4. Related description of the fuel cartridge 110 of FIG. 4 is similar to that of the fuel cartridge 110 of FIG. 2.

Taking the fuel unit 201 as an example, and other fuel units 202, 204, 205 and 206 are similar to the fuel unit 201. The fuel unit 201 has a first reactant R1 (for example, water) and a second reactant R2 (for example, NaBH₄). The fuel unit 201 further has a server device H1 (for example, a heating device) and a temperature sensing device S1. A diaphragm is disposed between the first reactant R1 and the second reactant R2 for isolation.

The control unit 210 selects at least one fuel unit (which is referred to as a first fuel unit, for example, the fuel unit 201) from the fuel units, and triggers the fuel unit 201 to provide the fuel (for example, hydrogen) to the fuel cell 120. If the first reactant R1 or the second reactant R2 in the fuel unit 201 is to be exhausted, an amount of the fuel provided by the fuel unit 201 is gradually reduced. When the fuel generated by the fuel unit 201 is insufficient to provide for the fuel cell 120, the control unit 210 sequentially selects at least another un-triggered fuel unit (which is referred to as a second fuel unit, for example, the fuel unit 202) from all of the fuel units, and triggers the second fuel unit 202. In the embodiment, the second fuel unit is adjacent to the first fuel unit, for example, the fuel unit 202 is adjacent to the fuel unit 201. In the embodiment, a method of sequentially triggering the adjacent fuel units is used, so that the reaction heat generated by the prior triggered fuel unit 201 may be used to heat the adjacent fuel unit 202. Therefore, in the low temperature application environment, the triggered fuel unit 202 may be maintained at an optimal reaction temperature, so that a better performance of the fuel cell system 100 may be maintained. However, the invention is not limited to the embodiment, and in other embodiments, the fuel units may be randomly triggered.

The control unit 210 is electrically connected to all of the fuel units and all of the temperature sensing devices. The temperature sensing device S1 detects a temperature of the fuel unit 201, and the temperature sensing device S2 detects a temperature of the fuel unit 202. If the temperature of the fuel unit 202 is lower than a predetermined upper-limit operating temperature, the control unit 210 triggers the fuel unit 202 to provide the fuel (for example, hydrogen) for the fuel cell 120. The predetermined upper-limit operating temperature is determined according to rated temperature tolerances of the fuel reaction, the fuel cartridge 110 and/or the fuel cell 120.

In some applications, if the environmental temperature is too high, the above sequential triggering operation method may probably lead to an excessive high reaction temperature. In the embodiment, the control unit 210 may monitor the temperature of each of the fuel units through the temperature sensing device. If the temperature of the second fuel unit (for example, the fuel unit 202) is higher than the predetermined upper-limit operating temperature, the control unit 210 selects at least another un-triggered fuel unit (which is referred to as a third fuel unit) from the fuel units, and triggers the third fuel unit to provide the fuel (for example, hydrogen) to the fuel cell 120, wherein the third fuel unit is not adjacent to the first fuel unit, for example, the fuel unit 204 is not adjacent to the fuel unit 201.

In other embodiments, the control unit 210 may monitor a temperature of the third fuel unit. If the temperature of the third fuel unit (for example, the fuel unit 204) is still higher than the predetermined upper-limit operating temperature, the control unit 210 abandons triggering the third fuel unit, and selects at least another un-triggered fuel unit (for example, the fuel unit 205 or 206) from the fuel units, and triggers such fuel unit to provide the fuel (for example, hydrogen) for the fuel cell 120.

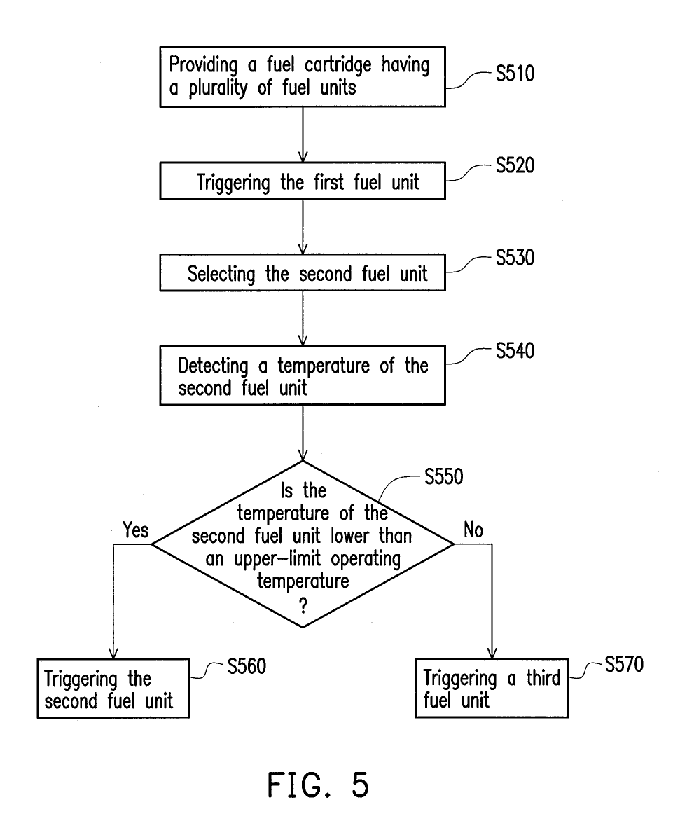

According to the above descriptions of the fuel cartridge 110, a method for operating the fuel cartridge is deduced below. FIG. 5 is a flowchart illustrating a method for operating a fuel cartridge of a fuel cell according to an embodiment of the invention. Firstly, the fuel cartridge 110 is provided (step S510), wherein the fuel cartridge 110 has a plurality of fuel units. At least one fuel unit (which is referred to as a first fuel unit hereinafter) is selected from the fuel units, and the first fuel unit is triggered to provide the fuel for the fuel cell 120 (step S520). If the fuel produced by the first fuel unit is insufficient to provide for the fuel cell 120, a step S530 is executed, by which at least another fuel unit (which is referred to as a second fuel unit hereinafter) is selected from the fuel units. In step S540, a temperature of the second fuel unit is detected. In step S550, if it is determined that the temperature of the second fuel unit is lower than an upper-limit operating temperature, a step S560 is executed, by which the second fuel unit is triggered to provide the fuel to the fuel cell 120. If the temperature of the second fuel unit is higher than the upper-limit operating temperature, at least another fuel unit (which is referred to as a third fuel unit hereinafter) is selected from the fuel units, and the third fuel unit is triggered to provide the fuel (step S570), wherein the third fuel unit is not adjacent to the first fuel unit.

In summary, since the fuel cartridge 110 is divided into a plurality of fuel units, and the chemical reaction may be occurred in each of the fuel units alone without be influenced by other fuel units, the control unit 210 may trigger one or more fuel units according to a power requirement of a load, so as to reduce a waste of the fuel (for example, hydrogen) and electric power. Moreover, the embodiment of the invention has at least one of the following advantages:
(1) Since excessive high temperature of the fuel units of the fuel cartridge 110 may be avoided, a high temperature of the fuel cartridge 110 is avoided, which may result in a safe utilization of the fuel cartridge 110, and damage of the fuel cartridge 110 due to the high temperature is avoided.
(2) Since excessive high temperature of the fuel units of the fuel cartridge 110 may be avoided, the fuel cell system 100 may be operated in a stable state, so as to stably provide electric power.
(3) The fuel cartridge 110 has a heating effect, so that it may be quickly activated under a low temperature, and the fuel cell 120 may have a higher performance.
(4) If the fuel cartridge 110 is equipped with the temperature sensing accessories, the reaction temperatures of the fuel units in the fuel cartridge 110 may be suitably controlled, so that the performance of the fuel cell 100 may be more stable.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for operating a fuel cartridge of a fuel cell, comprising:
providing the fuel cartridge comprising a plurality of fuel units;
selecting at least one first fuel unit from the fuel units, and triggering the first fuel unit to provide a fuel for the fuel cell;
selecting at least one second fuel unit from the fuel units if the fuel produced by the first fuel unit is insufficient to provide for the fuel cell;
detecting a temperature of the second fuel unit; and
triggering the second fuel unit to provide the fuel to the fuel cell if the temperature of the second fuel unit is lower than an upper-limit operating temperature.

2. The method for operating the fuel cartridge of the fuel cell as claimed in claim 1, further comprising:
selecting at least one third fuel unit from the fuel units if the temperature of the second fuel unit is higher than the upper-limit operating temperature, and triggering the at least one third fuel unit to provide the fuel, wherein the at least one third fuel unit is not adjacent to the first fuel unit.

3. The method for operating the fuel cartridge of the fuel cell as claimed in claim 1, further comprising:
detecting temperatures of the fuel units; and
triggering a heating device to heat the fuel units if the temperatures of the fuel units are lower than a lower-limit operating temperature.

4. The method for operating the fuel cartridge of the fuel cell as claimed in claim 1, the step of triggering the first fuel unit comprises:
triggering a heating device to burn a diaphragm of the first fuel unit, so that a chemical reaction is occurred between a first reactant and a second reactant in the first fuel unit to provide the fuel.

5. The method for operating the fuel cartridge of the fuel cell as claimed in claim 4, wherein the first reactant comprises a chemical hydrogen-storage material.

6. The method for operating the fuel cartridge of the fuel cell as claimed in claim 4, wherein the second reactant comprises a chemical hydrogen-storage material.

7. The method for operating the fuel cartridge of the fuel cell as claimed in claim 1, wherein the step of triggering the first fuel unit comprises:
piercing a diaphragm of the first fuel unit, so that a chemical reaction is occurred between a first reactant and a second reactant in the first fuel unit to provide the fuel.

8. The method for operating the fuel cartridge of the fuel cell as claimed in claim 1, wherein the fuel comprises hydrogen.

9. A fuel cartridge of a fuel cell, comprising:
a plurality of fuel units;
a temperature sensing device, for detecting temperatures of the fuel units; and
a control unit, electrically connected to the fuel units and the temperature sensing device, and capable of controlling the fuel units, wherein the control unit selects at least one first fuel unit from the fuel units, and triggers the at least one first fuel unit for providing a fuel to the fuel cell, if the fuel produced by the first fuel unit is insufficient to provide for the fuel cell, the control unit selects at least one second fuel unit from the fuel units, and if a temperature of the second fuel unit is lower than an upper-limit operating temperature, the control unit triggers the second fuel unit to provide the fuel for the fuel cell.

10. The fuel cartridge of the fuel cell as claimed in claim 9, wherein if the temperature of the second fuel unit is higher than the upper-limit operating temperature, the control unit selects at least one third fuel unit from the fuel units and triggers the at least one third fuel unit to provide the fuel, wherein the at least one third fuel unit is not adjacent to the first fuel unit.

11. The fuel cartridge of the fuel cell as claimed in claim 9, further comprising:
a heating device, electrically connected to the control unit, wherein if the temperatures of the fuel units are lower than a lower-limit operating temperature, the control unit triggers the heating device to heat the fuel units.

12. The fuel cartridge of the fuel cell as claimed in claim 9, further comprising:
a heating device, electrically connected to the control unit, wherein the control unit triggers the heating device to burn a diaphragm of the first fuel unit, so that a chemical reaction is occurred between a first reactant and a second reactant in the first fuel unit to provide the fuel.

13. The fuel cartridge of the fuel cell as claimed in claim 12, wherein the first reactant comprises a chemical hydrogen-storage material.

14. The fuel cartridge of the fuel cell as claimed in claim 12, wherein the second reactant comprises a chemical hydrogen-storage material.

15. The fuel cartridge of the fuel cell as claimed in claim 9, further comprising:
a piercing mechanism, electrically connected to the control unit, wherein the control unit triggers the piercing mechanism to pierce a diaphragm of the first fuel unit, so that a chemical reaction is occurred between a first reactant and a second reactant in the first fuel unit to provide the fuel.

16. The fuel cartridge of the fuel cell as claimed in claim 9, wherein the fuel comprises hydrogen.
